(19) United States
(12) Patent Application Publication
(10) Pub. No.: US 2014/0029710 A1
(43) Pub. Date: Jan. 30, 2014

(54) PRODUCTION OF TECHNETIUM FROM A MOLYBDENUM METAL TARGET

(71) Applicants: John Wilson, Edmonton (CA); Katherine Gagnon, Edmonton (CA); Stephen McQuarrie, Edmonton (CA)

(72) Inventors: John Wilson, Edmonton (CA); Katherine Gagnon, Edmonton (CA); Stephen McQuarrie, Edmonton (CA)

(73) Assignee: THE GOVERNORS OF THE UNIVERSITY OF ALBERTA, Edmonton, AB (CA)

(21) Appl. No.: 14/110,905

(22) PCT Filed: Apr. 10, 2012
(86) PCT No.: PCT/CA12/50230

§ 371 Date: Oct. 9, 2013

Related U.S. Application Data
(60) Provisional application No. 61/473,795, filed on Apr. 10, 2011.

(51) Int. Cl. G21G 1/00

(52) U.S. Cl. CPC G21G 1/001
USPC 376/189; 228/176

(57) ABSTRACT

Recycling of isotopically enriched molybdenum metal targets that are suitable for the large scale cyclotron production of ^{99m}Tc or ^{94m}Tc includes the charged particle irradiation of an enriched molybdenum metal target to produce a technetium isotope, separation of the technetium isotope following irradiation of the molybdenum, re-claiming the molybdenum metal and reformation of the molybdenum target for a further irradiation step. This process may then be repeated. Separation of the technetium isotope preferably is achieved by oxidative dissolution of the molybdenum thereby removing it from a target support plate, and forming molybdate and pertechnetate. The technetium isotope is isolated by various means, such as the ABEC process. To reuse the molybdenum, additional steps of isolating the molybdate and reducing it back to molybdenum metal are required. The recovered molybdenum metal may then be reformed as a target for example by pressing or pressing and sintering, followed by bonding to a target support plate.

### CROSS-REFERENCE TO RELATED APPLICATIONS

This application claims the benefit under 35 USC 119(e) of U.S. provisional application Ser. No. 61/473,795 filed Apr. 10, 2011.

### BACKGROUND

^{99m}Tc is the most widely used isotope in nuclear medicine today. ^{99m}Tc (t_{1/2}=6 h) is a gamma emitting radionuclide that is used in >80% of diagnostic nuclear medicine procedures and its source to date has been through the decay of reactor produced ⁹⁹Mo. The ⁹⁹Mo (t_{1/2}=66 h) is adsorbed onto a small column of alumina and the ^{99m}Tc can be eluted from this ‘generator’ daily until the ⁹⁹Mo has decayed to make further extraction uneconomical, usually in about 1-2 weeks.

Enriched molybdenum oxides have been used in the cyclotron generation of both ^{99m}Tc and ^{94m}Tc (a positron-emitting isotope which has been used in various clinical studies over the past two decades); however, the poor thermal conductivity of molybdenum oxide severely limits the amount of beam current that can be applied to these targets (they will either melt or become volatile at elevated temperatures resulting from the high beam current). ^{94m}Tc production using targets based on molybdenum oxide are typically limited to currents on the order of 5 μA. This is two orders of magnitude less than the desired 100-500 μA needed for large-scale cyclotron production of ^{99m}Tc, making oxide-based target design strategies for ^{94m}Tc or ^{99m}Tc impractical for large scale use.

The use of a “stacked” foil target design has been disclosed that includes number of different materials that can be used with a ¹⁰⁰Mo layer to produce ^{99m}Tc via the ¹⁰⁰Mo (p,2n) process (WO 2011/002323). The separate layers are not bonded together and therefore heat transfer between the layers during irradiation will be inefficient. Efficient heat transfer is essential to effectively disperse the energy generated by high energy >1 kW beams to the cooling systems of the cyclotron target to prevent excessive heating and the melting or volatization of the target materials.

The natural abundance of ¹⁰⁰Mo is 9.63%, and the high costs associated with the isotopic separation of ¹⁰⁰Mo from natural molybdenum makes target recycling very attractive. There has also been interest in the cyclotron produced ^{94m}Tc since it is a positron emitter (t_{1/2}=52.5 min) and has exactly the same well-established coordination chemistry as ^{99m}Tc. The most widely reported production strategy for ^{94m}Tc has been through proton irradiation of ⁹⁴Mo (9.25% of natural abundance) and thus, as in the case of ¹⁰⁰Mo(9.63%), target recycling is of great interest due to the cost of the enriched isotope. The majority of ^{94m}Tc targets have been made with MoO₃. Targets made with MoO₃ cannot withstand high beam currents due to their poor thermal conductivity and thus have limited production capabilities.

### SUMMARY

There is proposed recycling of isotopically enriched molybdenum metal targets that are suitable for the large scale cyclotron production of ^{99m}Tc or ^{94m}Tc. The process is a cycle formed of several subsidiary processes. In one embodiment, the process comprises the charged particle irradiation of a molybdenum metal target to produce a technetium isotope, oxidation of the molybdenum and resulting technetium, separation of the resulting pertechnate from the molybdate, isolation of the molybdate, reduction of the molybdate to molybdenum metal, and reformation of the molybdenum metal target for a further irradiation step. This process may then be repeated. Separation of the technetium isotope preferably is achieved by oxidatively dissolving the molybdenum target thereby removing it from a target support plate, followed by isolation of the technetium isotope by various means such as the aqueous biphasic extraction chromatography (ABEC) process. The ABEC and other separation processes that may be used require that the technetium is in the form of pertechnate and the molybdenum is in the form of an oxide, preferably molybdate. In order to recycle the molybdenum to make further targets, there are additional steps required to recover metallic molybdenum from the dissolved molybdate solution. The recovered molybdenum metal may then be reformed as a target for example by pressing or pressing and sintering, followed by bonding to a target support.

In another embodiment, the process comprises preparation of a technetium isotope, comprising irradiating a molybdenum metal target with charged particles to produce a technetium isotope, separating the technetium isotope following irradiation of the molybdenum metal, re-claiming the molybdenum metal, and reforming the molybdenum metal into a further molybdenum target for a further irradiation step. In another embodiment, this is disclosed a method for the preparation of a molybdenum metal target for irradiating with charged particles to produce a technetium isotope comprising bonding molybdenum metal to a target support.

In various embodiments there may be provided one or more of: reforming the molybdenum metal into a further molybdenum target comprises bonding the molybdenum metal to a target support, bonding the molybdenum metal to the target support comprises applying heat and pressure to a pellet of the molybdenum metal, pressure is applied under vacuum, reforming the molybdenum metal comprises pressing molybdenum metal powder and sintering the resulting pressed molybdenum metal powder to produce a pellet of the molybdenum metal before bonding the molybdenum metal pellet to a support, sintering is carried out under a reducing atmosphere, the pressed molybdenum metal is supported during sintering by a sintering support plate that is removed after sintering, the support is formed from a first material and the molybdenum metal is supported during sintering by a second material and the second material has a higher melting point than the first material, the pressed molybdenum metal is supported by an additional mass during sintering that is separated from the molybdenum metal pellet after sintering, the sintering support plate is made of any one or more of Ta, Ti, Pt, Zr, Cr, V, Rh, Hf, Ru, Ir, Nb, Os, alumina, zirconia and graphite, the additional mass comprises a cap, the cap made of any one or more of Ta, Ti, Pt, Zr, Cr, V, Rh, Hf, Ru, Ir, Nb, Os, alumina, zirconia and graphite, the target support comprises one or more of Al, Ag, Pt, Au, Ta, Ti, V, Ni, Zn, Zr, Nb, Ru, Rh, Pd and Ir, separating the technetium isotope comprises dissolving the molybdenum metal target to remove the molybdenum from the target support, and isolating the technetium isotope, separating the technetium isotope comprises oxidizing the molybdenum metal target to soluble molybdate using hydrogen peroxide to form a solution, and the technetium isotope is isolated as pertechnate, isolating the molybdate by lyophilization and reducing the isolated molybdate to molybdenum metal, separating the technetium isotope comprises, neutralizing the solution for example with ammonium carbonate, dissolving takes place under dissolution conditions and the target support is impervious to the dissolution conditions, isolating the technetium isotope comprises using aqueous biphasic extraction chromatography, the technetium isotope is ^{99m}Tc and the technetium isotope is ^{94m}Tc.

### BRIEF DESCRIPTION OF THE FIGURES

Embodiments will now be described with reference to the figures, in which like reference characters denote like elements, by way of example, and in which:

FIG. 1 shows a complete cycle of technetium production.

FIG. 2 shows method steps for separating technetium from molybdenum.

FIG. 3 shows method steps for recovering molybdenum metal from ammonium molybdate.

FIG. 4 shows the fabrication of a metal target.

FIG. 5 shows a cross sectional schematic of pressed molybdenum powder/tantalum plate assembly along with tantalum cap used to prevent bowing of molybdenum while sintering.

FIG. 6 is a graph showing sample measured temperature profile of both the top and bottom heating elements of the SUSS wafer bonding system.

FIG. 7 shows an SEM Profile of Mo/Al/Cu plate.

FIG. 8 shows a sintered ^{nat}Mo target post-irradiation.

FIG. 9 shows a schematic for separation of technetium from a dissolved target.

FIG. 10 shows a sample temperature profile for steps for reducing ammonium molybdate to molybdenum metal.

### DETAILED DESCRIPTION

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

To prevent melting/volatilization of the expensive ¹⁰⁰Mo (or ⁹⁴Mo for ^{94m}Tc) target at the high power irradiations needed for the large-scale production of ^{99m}Tc, metallic Mo targets must be used as the metallic thermal properties that are compatible with the high power irradiations needed for the large-scale production of ^{99m}Tc. To tolerate the high-power irradiations and maintain adequate structural stability, the enriched ¹⁰⁰Mo powder must be formed or deposited as a solid structure. A new metallic target preferably should (1) have the ability to fabricate a target with sufficient thickness for optimal proton capture at high beam current—a factor which will depend on irradiation energy and target angle, (2) have the ability to deposit/adhere the molybdenum onto a target support plate, (3) not lose expensive enriched molybdenum during target preparation, (4) provide for adequate heat removal under high power irradiations and (5) be easy to fabricate and allow the construction of multiple targets simultaneously.

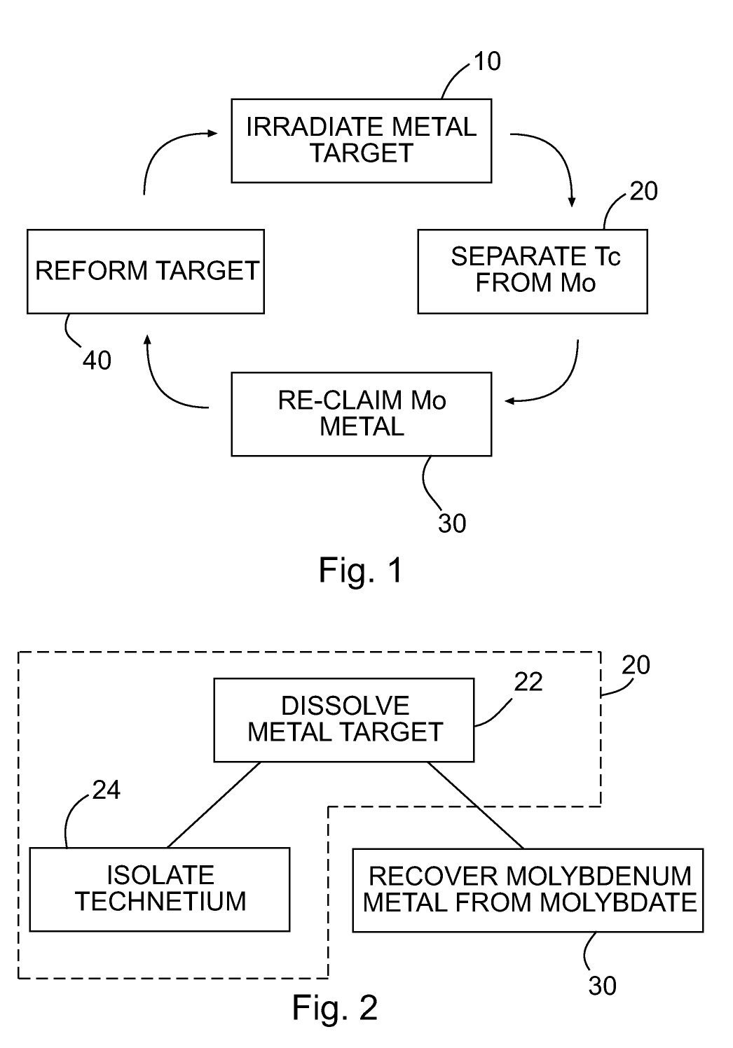

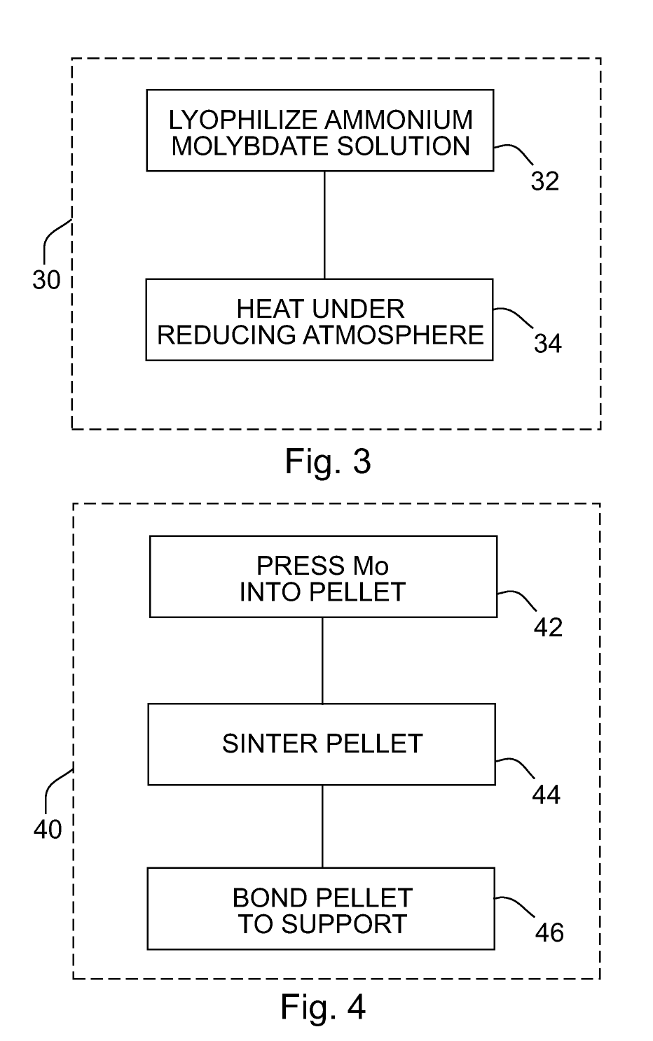

In one embodiment, the disclosed process comprises recycling of isotopically enriched molybdenum metal targets that are suitable for the large scale cyclotron production of ^{99m}Tc or ^{94m}Tc. The process is a cycle formed of several subsidiary processes. Referring to FIG. 1, an exemplary process comprises the charged particle irradiation 10 of a molybdenum metal target to produce a technetium isotope, separation 20 of the technetium isotope following irradiation of the molybdenum, re-claiming 30 the molybdenum metal and reformation 40 of the molybdenum target for a further irradiation step 10. This process may then be repeated. After irradiation, the metallic molybdenum target is preferably dissolved and separated in such a way that the final product allows for simple purification of the desired ammonium molybdate. Referring to FIG. 2, separation 20 of the technetium isotope preferably is achieved by oxidatively dissolving 22 the molybdenum target thereby removing it from the target support plate, followed by isolation 24 of the technetium isotope by various means. Examples of strategies for separation of pertechnetate (from the bulk molybdate) can be achieved using, for example, known liquid-liquid extraction, ion-exchange chromatography, aqueous biphasic exchange chromatography, ABEC™ or electrochemistry. Sublimation based strategies for separation of technetium from bulk molybdenum are also known—such strategies also require the molybdenum to be in an oxide form prior to efficient extraction of technetium. Prior to separation of the radio technetium (using ABEC or other processes), the molybdenum metal must first be oxidized to molybdate. In this work ammonium molybdate was strategically selected although other forms could be possible. Following technetium extraction, there are the additional steps of 30, isolating the ammonium molybdate and reducing it to molybdenum metal. As shown in FIG. 3, the process 30 of recovering molybdenum from the molybdate may comprise lyophilisation 32 of ammonium molybdate solution to remove volatile salt and water, and heating 34 of the dried and purified ammonium molybdate for example under a reducing atmosphere. As shown in FIG. 4, the recovered molybdenum may then be reformed 40 as a target for example by pressing or pressing 42 and sintering 44 (for example, densification of the pellet may occur by heating the pressed molybdenum metal powder under a reducing atmosphere at a temperature of 1600° C.), followed by bonding 46 to a target support. For example, the produced molybdenum pellet may be removed from the tantalum sintering support plate and then bonded to an aluminum or copper or other suitable target support plate by applying heat and pressure to the pellet under vacuum.

The targets for the ¹⁰⁰Mo→⁹⁹Mo→^{99m}Tc process is known, in which the ^{99m}Tc is separated from the ¹⁰⁰Mo target by sublimation. Separation of radio-technetium from bulk molybdenum by the method of sublimation has been well described and has several variants. The sublimation requires that the molybdenum be in the form of an oxide, such as molybdate. Most commonly the target is heated under a controlled oxygen atmosphere in a quartz tube. The resulting volatile oxidized technetium and molybdenum species flow through the tube (e.g. by addition of a gas and/or by natural convection). Due to the temperature gradient in the tube, and higher vapour pressure of the technetium species, separation is achieved as the two species adsorb at different locations on the quartz tube wall. The resulting molybdate is reduced back to molybdenum metal at >600° C. under an atmosphere of hydrogen. Sublimation has been extensively documented for ^{94m}Tc separation from ⁹⁴Mo, as well as ^{99m}Tc from ^{98/99}Mo (from neutron activation of ⁹⁸Mo). It has been discussed with regards to ¹⁰⁰Mo, but the amount of experimental data is limited.

The exemplary embodiment is primarily focussed on ^{99m}Tc production (using enriched ¹⁰⁰Mo targets); however, by virtue of the nature of the processes used and the properties of the materials (i.e. differently isotopically enriched samples of the same metals), it can be soundly predicted that the disclosed methods may be applied to any situation where an enriched molybdenum metal target is irradiated with a charged particle beam for the purpose of producing a desired technetium isotope such as the medically relevant ^{94m}Tc isotope (using enriched ⁹⁴Mo targets). Although the method may also be applied to non-enriched molybdenum, there is no need to pursue the cycle if non-enriched, i.e. natural abundance, molybdenum was used since natural abundance molybdenum (^{nat}Mo) is extremely inexpensive, thus there would be no cost-benefit to recycling under current economic conditions.

The choice to use metal molybdenum targets (as opposed to molybdenum oxide) is because they can withstand much higher beam currents and will thus allow for production of much greater quantities of the desired technetium product. Unlike molybdenum oxide, the use of molybdenum metal requires further purification and processing to recover the metal, as it is converted to the oxide for pertechnetate recovery. Moreover, the metal is either purchased or recovered in powder form, which requires further processing to be compatible with a cyclotron target assembly. Several strategies were evaluated for use in constructing a molybdenum cyclotron target from molybdenum powder.

One option is to press the molybdenum metal powder into a target support plate. This method is easy to prepare but poses two problems. First, the grains of powder are not guaranteed to have good thermal contact between one another. Consequently, the molybdenum target may not maintain its integrity during irradiation. Second, while the powder is somewhat secure, it likely will not maintain its integrity after being manoeuvred, transported or bumped around. This thus poses a potential concern for loss of highly radioactive target material following irradiation. The problem of target material loss during transport may however be alleviated through the addition of a cover foil. This is reasonably easy to prepare and provides better strength during transport. The use of cover foils however leads to further complexities with regards to cooling, poor thermal contact between the grains and increased difficulty in post-processing as the foil must be removed remotely since the target is radioactive. Experimentally, we have irradiated pressed molybdenum targets, but have not used a cover foil. With regards to pressing conditions, we tried adding a small amount of powder, pressing, adding a bit more powder, pressing, and so on until the desired mass of powder was pressed. Alternatively, we pressed all powder at once. The single “at once” strategy gave far superior results over the multiple pressing steps. The use of an enriched metallic molybdenum foil target is also possible (as it would have the best strength during transport and good thermal performance). No target support plate would be needed for the molybdenum foil system, thus there would be no concern for plate contaminants. Irradiations on natural abundance molybdenum foil have been performed, however, enriched molybdenum foils are not commercially available in the needed thicknesses. Another option for the preparation of the target is by melting the molybdenum, which would increase the strength of the target during transport and provide better thermal characteristics for the molybdenum. We have attempted to melt the molybdenum into a target support plate made of tantalum via e-beam melting. With the high melting point of molybdenum however, this resulted in the need for exquisite temperature control and the selection of target support plate materials was limited to those with a high melting point which do not necessarily have good activation or thermal properties compatible with high current irradiations. Unable to achieve the needed control, this led to unsuccessful target preparation using this strategy. Even if success is found with this method, one problem is the time and efficiency in producing targets large scale with this method, it is questionable if many targets could be done at once. A better process for target preparation was determined to be sintering. Sintering could be an overnight process, it requires little user intervention (that is, you turn it on and collect the samples in the morning), plus offers the ability to do many targets at once (so far we've sintered 7 at once, but have capacity for several more). Melting on the other hand seems to involve a greater level of control, monitoring and preparation, and depending on the system used, may not be easily scalable.

Given the transport strength and irradiation integrity concerns, we wanted a target design with improved strength and thermal contact. For this, we have explored sintering. Sintering is a strategy whereby the grains of the powder densify (even though the melting point of the material has not been achieved). For this, we press the targets into a material of high melting point (we've used tantalum, but other inert materials with high [>1600° C.] could be used). The targets are preferably heated under a reducing atmosphere (we have used a H₂ atmosphere at 1600° C.) to yield solid pellets of molybdenum metal. To prevent bowing of the resulting exemplary pellets, the use of “caps” during sintering was found essential to ensure flat molybdenum pellets were formed. Although the sintered metallic molybdenum pellets are not found to adhere to the sinterering support plate during the sintering process, a bonding step can be implemented to bond the pellet to a target support plate for irradiation purposes. Compared with a pressed powder (non-sintered) scheme, the resulting sintered and bonded target has increased strength during transport and improved thermal contact between the molybdenum metal and the target support plate. A wide selection of target support plate materials may also be used. Preparation via sintering takes a bit of time, however many targets may be prepared at once.

Initial sintering optimization studies were performed with ^{nat}Mo. The molybdenum/tantalum assembly was prepared using either commercially available metallic ^{nat}Mo (Aldrich, ≧99.9% metal basis), or from hydrogen reduction of [^{nat}Mo]-ammonium molybdate. The enriched targets were prepared from commercially purchased metallic ¹⁰⁰Mo (Trace Sciences International); ¹⁰⁰Mo (97.39%), ⁹⁸Mo (2.58%), ⁹⁷Mo (0.01%), ⁹⁶Mo (0.005%), ⁹⁵Mo (0.005%), ⁹⁴Mo (0.005%), and ⁹²Mo (0.005%). The desired quantity of molybdenum metal powder (300-350 mg) was placed into a 0.5 cm×1.0 cm×0.1 cm (semi-minor×semi-major×depth) elliptical well of a tantalum sintering support plate and hydraulically pressed using a hardened steel die. Placing the molybdenum/tantalum assembly into a Carbolite TZF 16/610 furnace, the molybdenum was heated using the following temperature control parameters (Table 1) under hydrogen atmosphere (UHP, 5.0) at nominal flow rates of 750-1000 sccm (750 sccm was used for the final enriched ¹⁰⁰Mo pellets).

TABLE 1
Programmed temperature profile used for
sintering of molybdenum metal pellets

| | Temperature | Programmed Temperature |
|---|---|---|
| Step | Range[° C.] | Rate [° C./min] |
| 1 | 25 →600 | 5 |
| 2 | 600 (hold × 1 hr) | 0 |
| 3 | 600→1000 | 5 |
| 4 | 1000 (hold × 1 hr) | 0 |
| 5 | 1000→1600 | 5 |
| 6 | 1600 (hold × 3 hr) | 0 |
| 7 | 1600→25 | −5 |

While steps 2 and 4 of Table 1 were not necessarily essential for sintering, these two steps were added as an attempt to reduce trace oxides prior to sintering. The extent to which such hold points are needed is unknown, but may be readily determined by experimentation. The elliptical sintered metallic molybdenum pellets are reduced in size from the original target shape. The reason for this is not because of mass loss (typical losses of <2% are noted). Instead, the reduction in size is due to an increase in density. One of the benefits identified with sintering is that the resulting pellet does not adhere to the tantalum support plate during the sintering procedure. This is beneficial since the pellet can be removed and placed into a target support plate constructed of a different material which might be better suited for the irradiation step. Tantalum, as well as other high temperature metals that are good candidates to support the pellet during sintering, don't necessarily have the properties that are desired when it comes time to irradiate the target. Conversely, materials that are well-suited for irradiation, do not necessarily have melting points that are compatible with the high temperatures needed for sintering (for example Al and Cu). Excellent contact is observed between the metallic molybdenum powder grains. To ensure that sintering occurred throughout the pellet (i.e. not just the surface) a sintered pellet was broken in two and an SEM image obtained edge-on and sintering was observed throughout the pellet. In this study, pellet densities of up to 93% were observed, and mass losses following sintering were typically less than 2%.

Tantalum was selected as the molybdenum support during the sintering process as it has a high melting point and is chemically inert under the sintering conditions. While other metals could have been selected for the molybdenum support (including for example, but not limited to metals such as Ti, Pt, Zr, Cr, V, Rh, Hf, Ru, Ir, Nb, Os or materials such as alumina, zirconia, graphite, etc) tungsten should preferably not be used at any point during the target preparation since proton activation of trace contaminants of tungsten will yield rhenium. Having chemical similarities to technetium, any contaminant rhenium will add an additional level of complexity with regards to final ^{99m}Tc purification.

One significant challenge that arose during our initial ^{nat}Mo studies was that the sintered pellets were notably bowed. This was problematic with regards to the subsequent required bonding step as flat molybdenum pellets were desired. As shown in FIG. 5, a 2 mm thick cap 50 was placed atop the molybdenum 54 during the sintering process to supply additional mass and structural support for the molybdenum. The cap 50 may be made of any one or more of Ta, Ti, Pt, Zr, Cr, V, Rh, Hf, Ru, Ir, Nb, Os, alumina, zirconia and graphite or other suitable materials. The elliptical cap 50 was a male cut-out to the existing 0.5 cm×1.0 cm semi-axes tantalum well 56 formed in the tantalum support 52. This small amount of additional mass proved sufficient to eliminate any notable bowing of the molybdenum pellet. After the molybdenum pellet is formed, it is removed from the sintering support for subsequent bonding to a target support plate. Known techniques for improving the sintering process may also be used such as addition of zinc stearate or other materials as a binder, use of moist hydrogen, vacuum and various modifications to the temperature and sintering time.

Considering material selection of a target support plate in which to bond the metallic molybdenum pellet, we have demonstrated that molybdenum may be bonded onto an aluminum plate, as well as molybdenum onto a copper plate (indirectly through use of an intermediary aluminum foil has been shown, although direct bonding may be possible). Any suitable support material may however be used such as one or more of Ag, Pt, Au, Ta, Ti, V, Ni, Zn, Zr, Nb, Ru, Rh, Pd and Ir. To bond the pellet, pressure may be applied at elevated temperatures (for example, 400-500° C.). Experiments have been carried out in vacuum (5×10⁻⁴ Torr), although it is not yet known if a vacuum is necessary. Routine experimentation may determine the optimal pressure, temperature, and atmosphere for bonding depending on the support plate material that is used.

In an embodiment, see FIG. 8, the target support plates 60 were constructed of 6061 aluminum. Aluminum was selected as it is minimally activating, it is easily machined, it is inexpensive (thus plates do not need to be re-used), it has a reasonable thermal conductivity, and it is chemically inert to the dissolution system we have implemented for ^{99m}Tc extraction (i.e. dissolution via hydrogen peroxide followed by basification with ammonium carbonate). In addition to an elliptical well 62 that was identical in size to that of the tantalum plates, an o-ring groove 64 (i.e. to maintain helium cooling during irradiation) was also machined into the aluminum plates. Prior to bonding of the molybdenum onto the aluminum, the aluminum plates were cleaned by soaking overnight in a solution of ˜50 mL of 29-32% w/w H₂O₂ (Alfa Aesar, ACS Grade) and ˜150 mL of 70% HNO₃ (Sigma-Aldrich, ACS Grade).

For bonding of the molybdenum to aluminum we prefer the application of both heat and a compressive force under a vacuum atmosphere. To this end, molybdenum pellets 54 were placed into the well 62 on the aluminum target support plate 60. Since the molybdenum sits below the top of the well, for the purpose of applying pressure, one of the tantalum caps 50 described above was placed on top of the molybdenum (i.e. the molybdenum was sandwiched between the tantalum cap 50 and the aluminum target support plate 60). This sandwiched molybdenum assembly was subsequently loaded into the ELAN CB6L (SUSS MicroTec) wafer bonding system located at the University of Alberta's Micro and Nanofabrication facility (NanoFab, Edmonton, AB).

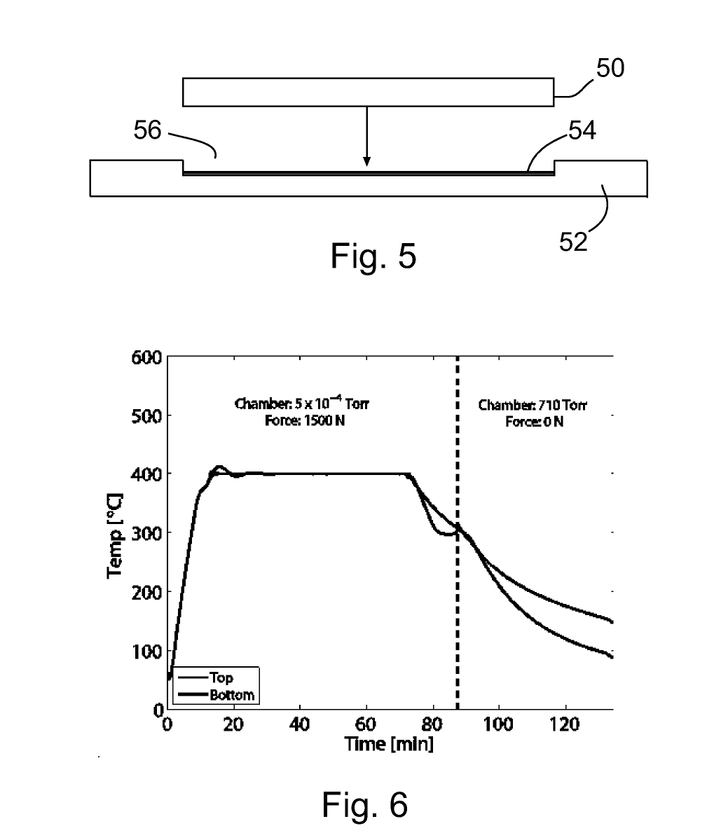

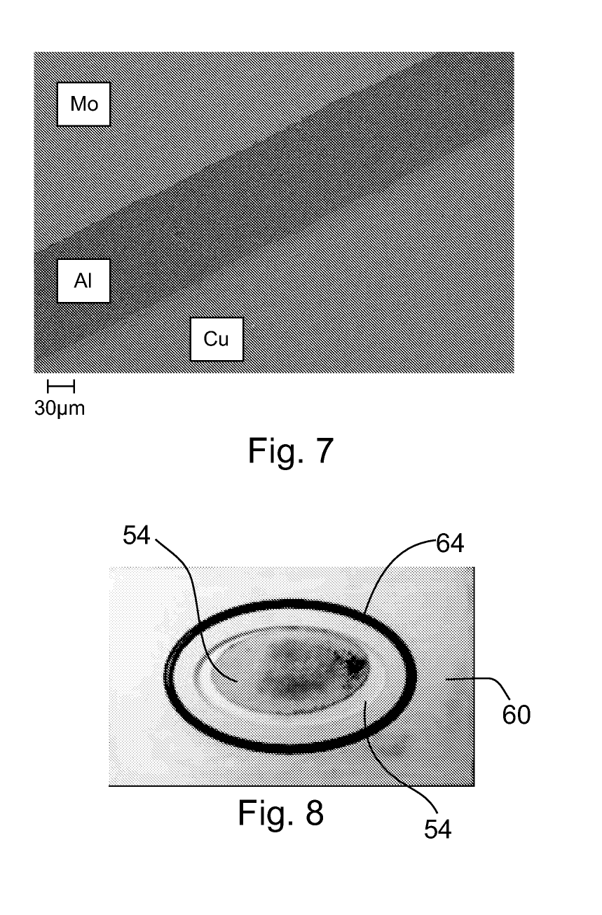

Compressive bonding of molybdenum onto aluminum was achieved by evacuating the chamber to 5×10⁻⁴ Torr, applying a compression force of 1500 N to the sandwich configuration, and heating both the top and bottom heating elements to 400° C. (held for one hour). To avoid oxidation of the molybdenum, heating elements were allowed to cool to 300° C. prior to venting of the chamber and releasing the applied force. A typical temperature/chamber vacuum/compression cycle is given in FIG. 6. An example of bonded Mo—Al—Cu is shown in FIG. 7.

While elevated temperature and pressure conditions were attempted using the maximum system parameters (i.e. 500° C. and 8800 N), such attempts proved problematic as the aluminum target plate bonded directly onto the lower heating element of the bonding system. For this reason, all further bonding studies were performed with an extra 3 mm protective steel plate in place between the bonding system and the aluminum plate.

A total of three ^{nat}Mo and three ¹⁰⁰Mo targets were bonded as described above. To verify adherence/structural stability, the three ^{nat}Mo targets were dropped onto the ground from a height of approximately 1.5 m. Two of the three targets remained adhered; the reason for separation in the third target is unknown. One of the remaining ^{nat}Mo bonded pellets was further tested by placing it on a hot-plate pre-set to 550° C. for ˜90 seconds, upon which it was then immediately removed, immersed liquid nitrogen, and once again dropped from a height of approximately 1.5 m. Aside from evidence of oxidation on the surface of the molybdenum (i.e. from heating in air), the target remained intact. The ¹⁰⁰Mo targets were not dropped.

Enriched ¹⁰⁰Mo targets prepared by this strategy were found to maintain structural stability following irradiation. While pellets were bonded to the aluminum target plate one-by-one it should be possible to adapt the setup to allow for simultaneous bonding of many targets at once for the purpose of scale-up.

Test irradiations were performed on the two remaining ^{nat}Mo sintered/bonded plates, and the three ¹⁰⁰Mo sintered/bonded plates. All targets were oriented at 30 degrees to the beam, and irradiations were performed on the variable energy TR 19/9 Cyclotron (Advanced Cyclotron Systems Inc., Richmond, BC), at the Edmonton PET Centre (Edmonton, AB). A summary of the irradiation conditions is given in Table 2.

TABLE 2
Irradiation conditions for the ^{nat}Mo and ¹⁰⁰Mo targets prepared in this study

| | | Mo Target | | Operating | Integrated | Average | Irradiation |
|---|---|---|---|---|---|---|---|
| | | Mass | Energy | Current | Current | Current | Length |
| Sample | Material | [mg] | [MeV] | [μA] | [μA min] | [μA] | [min] |
| 1 | ^{nat}Mo | ~350 | 17.5 | 95 | 972 | 49 | 20 |
| 2 | ^{nat}Mo | ~350 | 17.5 | 80 | 1500 | 71 | 21 |
| 3 | ¹⁰⁰Mo | ~300 | 18.0 | 80 | 25551 | 71 | 360 |
| 4 | ¹⁰⁰Mo | ~300 | 18.0 | 80 | 25002 | 69 | 360 |
| 5 | ¹⁰⁰Mo | ~300 | 18.0 | 45 | 14750 | 41 | 360 |

For the purpose of ensuring maximum beam on target (e.g. rather than losing beam on the helium cooling assembly of the target), a thermocouple was affixed to the helium cooling section of the target and monitored real-time throughout the irradiation. Efforts were made to minimize the temperature on the helium assembly (temperatures were typically maintained below 80° C.). This optimization required significant beam tuning (e.g. sometimes upwards of an hour), and it is largely for this reason that the operating currents of Table 2 differ significantly from the average current.

Following irradiation, the sintered ^{nat}Mo targets were left for an extended period of time to decay prior to visual inspection. While evidence of oxidation was seen on the surface of the molybdenum, mass losses were evaluated for sample 2 (Table 2), and no significant mass losses were observed following irradiation (mᵢₙᵢₜᵢₐₗ=4.6417 g; m_{final}=4.6418 g).

The ¹⁰⁰Mo targets were removed (typically 30-45 minutes post-EOB) by remotely dropping the target using an air actuated release mechanism into a lead container. The distance dropped was approximately 10 cm and all targets remained intact during this process. The shielded container was transferred to a hot-cell and the targets were processed immediately to extract the [^{99m}Tc]TcO₄⁻.

For the irradiated ¹⁰⁰Mo targets in this study, [^{99m}Tc]TcO₄⁻ was extracted using a Bioscan Reform Plus module which was adapted to accommodate existing aqueous biphasic extraction chromatography (ABEC) technology. For all three batches, successful recovery of more than a Curie of ^{99m}Tc (non-decay corrected) is reported (i.e. 60.5 GBq, 51.9 GBq, and 44.7 GBq). Typical extraction times of 30 minutes are reported with this system. The time between EOB and assaying of the final ^{99m}Tc activity varied from 101-136 minutes as the target was left to decay for approximately 30-45 minutes prior to removal. Evaluating the extracted [^{99m}Tc]TcO₄⁻, we note that the Al³⁺ concentration, pH, and radiochemical purity were all within USP limits (US Pharmacopeia, 2011). After evaluating contributions from ^{94g}Tc, ^{95m}Tc, ^{95g}Tc, ^{96g}Tc, and ^{97m}Tc, the radionuclidic purity of ^{99m}Tc was in excess of 99.9% at EOB. Radiochemical purity of the labeled MDP was found to be greater than 98% up to 24 hours post labeling.

TABLE 3
Percent of theoretical saturated yield based on assays performed prior
to extraction, and post extraction with comparison to 4.8 GBq/μA.

| | Pre-extraction | Post-extraction |
|---|---|---|
| Sample | Yield [%] | Yield [%] |
| 3 | 57 | 46 |
| 4 | 54 | 38 |
| 5 | 66 | 55 |

Comparison between the recovered and theoretical ^{99m}Tc yields (Table 3) suggests that improvements may be obtained from optimization of the chemical extraction system (e.g. mass of resin, flow rates, etc.). A more compact and efficient dissolution system will avoid the loss of technetium during the dissolution step as it is carried away with the evaporating peroxide/water vapours. Creating oversized molybdenum target pellets to account for pellet size reduction due to density increase following sintering, and reducing any loss of beam on the helium cooling assembly of the target system (despite efforts to minimize this contribution by temperature monitoring) will also increase ^{99m}Tc recovered yields.

We have successfully produced Curie quantities of high quality [^{99m}Tc]TcO₄⁻ using the proposed sintered target preparation strategy. Successful irradiation of these newly developed targets to beam powers in excess of 1 kW is reported, and targets have been found to maintain good structural stability post-irradiation (i.e. allowing for remote/automated target recovery). Following irradiation of these targets, along with a modified automated synthesis module, Curie quantities of high quality ^{99m}Tc have been extracted. Considering that previous ^{94m}Tc enriched molybdenum targetry systems were typically limited to irradiation currents on the order of 5 μA, the proposed strategy (which is amenable to the simultaneous preparation of several targets at once) is a great step forward with regards to achieving large-scale cyclotron production of ^{99m}Tc.

Target plate metals preferably should be, thermally conductive, chemically inert, and not, or at least insignificantly, activated by the proton beam or other particle beam during irradiation. In cases of preparing the target by fixing the molybdenum onto a target plate of another metal, it is preferred that the target plate is impervious to the dissolution conditions used in the process. Any ions that are introduced in the dissolution process: either by the dissolution solution itself, or from the target plate should be removed prior to reclaiming the molybdenum for preparation of future targets as these contaminants will accumulate rapidly during continued recycling. Furthermore, metal ionic contaminants can be activated during the irradiation process generating radioactive by-products.

Various solvents and solvent conditions may be used to dissolve molybdenum from target plates. Several such dissolution conditions have been examined, and each dissolution condition has disadvantages and considerations that should be taken into account. Examples include: using a 1:2:1 mixture of sulfuric acid:nitric acid:hydrogen peroxide (H₂O₂) at 60° C. is highly corrosive to wide variety of target plate materials, especially the two with the highest thermal conductivity, aluminum and copper, and the sulfate is difficult to remove. The nitrate can be removed but this interferes with separation of ^{99m}Tc. A 3:1 mixture of 6M nitric acid:H₂O₂ at 60° C. can be withstood by an aluminum target plate, and the nitrate can be removed but this interferes with the separation of ^{99m}Tc. 12% sodium hypochlorite at 60° C. can be withstood by an aluminum plate target, the chloride is difficult to remove and a prolonged reaction time is required. We prefer a solution of hydrogen peroxide, for example 30% H₂O₂ at 50-60° C., which can be withstood by an aluminum target plate, no addition ions are added and the mild acidity of final solution can be neutralized with ammonium carbonate or other suitable base which facilitates ^{99m}Tc separation using the ABEC system. Using the conditions described herein, no additional counter ions (e.g. metal, sodium, potassium, or chlorine) are added in the separation: these are typically difficult to remove once introduced as is the case with the previously disclosed methods described above, and extra purification steps are needed to efficiently separate these additional impurities from the desired technetium and molybdenum. As the separation process of this disclosure generates a solution of molybdate with no added ions other than carbonate, the final ammonium molybdate containing fractions can be subjected to lyophilisation to result in the isolation of ammonium molybdate without any additional purification steps. The use of 30% H₂O₂ at 50-60° C. is clearly superior and is thus preferred. However, other solvents and conditions may be used in some embodiments as may be known or readily developed by a person of average skill in the art.

Example 1 of dissolution of an irradiated target: Following ¹⁰⁰Mo irradiation, the irradiated target plate was placed in a beaker on a hot-plate set at 60° C. Through use of remote manipulators, the molybdenum was dissolved by step-wise addition of ˜10 mL of 29-32% w/w H₂O₂ (Alfa Aesar, ACS Grade) and then basified by addition of 2 mL of 3M (NH₄)₂CO₃. The basified solution was transferred into a sealed 20 mL vial, and the dissolution beaker was further rinsed with 8 mL of 3M (NH₄)₂CO₃ and added to the sealed vial. The vial activity was assayed (^{99m}Tc setting [i.e. Calibration #079], CRC-15PET dose calibrator) prior to further processing.

Example 2 of dissolution of an irradiated target: The pressed metallic molybdenum targets were dissolved by heating them in a beaker at 50-60° C. for 5 minutes after which 5 mL of fresh 29-32% w/w H₂O₂ (Alfa Aesar, ACS Grade) was added. After leaving the H₂O₂ to react for five minutes without agitation, 1 mL of 3M (NH₄)₂CO₃ (Alfa Aesar, ACS Grade) was added to basify the solution. After ˜1-2 minutes and visual inspection to ensure a pale yellow color of the solution (as opposed to dark red), the solution was removed from the heat and left to sit for ˜1 minute. Since it is reported elsewhere that in low hydrogen peroxide concentrations a yellow diperoxomolybdate species is formed, while a large hydrogen peroxide excess leads to formation of a brownish-red tetraperoxomolybdate species, we have attributed the observed color change to decomposition of excess hydrogen peroxide. The solution was then poured into an open-ended 30 mL syringe (preloaded with 1 mL of 3M (NH₄)₂CO₃). The dissolution beaker was further rinsed with 5 mL of 0.5 M (NH₄)₂CO₃ and poured into the 30 mL syringe.

Following oxidative dissolution of the molybdenum and technetium, the materials are in solution and the pertechnetate may be removed from the molybdate by the known ABEC process (or other processes). Following technetium extraction, the molybdate may be isolated by lyophilisation. Since the dissolution process renders the solution acidic, the solution was basified using (NH₄)₂CO₃ A (NH₄)₂CO₃ salt was selected for two reasons. First, it is important to select a biphase-forming anion (e.g. CO₃²⁻) to be compatible with the ABEC resin. Second, in developing a strategy for ^{99m}Tc extraction which is conducive to ¹⁰⁰Mo recycling, we have limited the solutes to volatile salts to facilitate evaporative purification of the ammonium molybdate.

As is known, the ABEC resin is capable of differentiating between ionic species based on charge and size from strongly ionic solutions that favour biphasic properties. It has been demonstrated that salts of pertechnetate and molybdate ions can be separated from strongly ionic solutions due to selective retention of the pertechnetate ion on the ABEC resin. The pertechnetate is subsequently washed off the resin with water.

Two independent sets of experiments were performed relating to target processing. One set of experiments entailed the high current sintered target irradiations outlined in Table 2. The purpose of these high current irradiations was to evaluate the thermal performance of the sintered targets, and strive for Curie quantity production of ^{99m}Tc. A second set of irradiations was performed in which the purpose was to examine in detail the molybdate isolation, reduction, and recycling scheme, but produce only limited quantities of ^{99m}Tc. For this latter set of experiments, pressed molybdenum metal targets were used, and the nominal proton extraction energy of 14.3 MeV was further reduced to 12.1 MeV using an aluminum degrader. Since ⁹⁹Mo and ¹⁰⁰Mo cannot be chemically separated, irradiation at 12 MeV allowed for transportation of the isolated molybdenum off-site (for reduction) within a few weeks post irradiation (i.e. limited contaminant ⁹⁹Mo to decay). To verify the irradiation current, a titanium monitor foil was also in place for all irradiations. With this setup, the ¹⁰⁰Mo was sufficiently thick to achieve a proton exit energy of ˜6.5 MeV (i.e. well below the ¹⁰⁰Mo(p,2n)^{99m}Tc reaction threshold). Irradiation conditions for this second set of experiments is given in Table 4.

TABLE 4
Irradiation conditions for new (N) and
recycled (R) ¹⁰⁰Mo metal targets.

| | Irradiation | Irradiation Time | Mass of ¹⁰⁰Mo |
|---|---|---|---|
| Sample ID | Current [μA] | [min] | [mg] |
| 1-N | 20 | 80 | 186 |
| 2-N | 20 | 79 | 175 |
| 3-N | 30 | 72 | 182 |
| 4-N | 20 | 80 | 175 |
| | | | Mean: 180 + 5 |
| 1-R | 20 | 80 | 174 |
| 2-R | 30 | 60 | 177 |
| 3-R | 25 | 80 | 178 |
| | | | Mean: 176 + 2 |

For both the high-current sintered target set of experiments and the detailed recycling set of experiments, the ABEC extraction process was implemented for isolation of the pertechnetate. Due to the high radiation dose burden imposed by the high-current irradiations, we adapted an automated Bioscan Reform Plus module to perform the (previously manual) extraction of the ^{99m}Tc.

Example 1 of ^{99m}Tc separation from irradiated targets: Following peroxide dissolution and basification with (NH₄)₂CO₃ of the ¹⁰⁰Mo target irradiations outlined in Table 2, the dissolved target solution was purified using an automated Bioscan Reform Plus module modified for extraction of [^{99m}Tc]TcO₄⁻ using a known aqueous biphasic extraction chromatography system (for example, as disclosed in U.S. Pat. No. 5,603,834). With this module, the dissolved solution was passed through a column of 500 mg of 100-200 mesh ABEC-2000 resin (Eichrom) and the pertechnetate was retained. The molybdate eluate was collected for future recycling. The column was then washed with 1 mL of 3 M ammonium carbonate solution to remove residual molybdate, followed by 3 mL of 1 M sodium carbonate solution. The high salt concentrations were necessary to prevent elution of the pertechnetate. The ABEC column was washed with 10 mL of sterile water to remove the pertechnetate and the resulting solution was passed through a strong cation exchange column (All-Tech) to reduce the pH to acceptable levels. Both ammonium carbonate (Alfa Aesar, ACS Grade) and sodium carbonate (Fisher Scientific, ACS Grade) solutions were freshly prepared using sterile water prior to the separation. Conditioning of the columns involved washing the ABEC with 20 mL of 3 M ammonium carbonate, and the SCX with 10 mL of sterile water. The activity of the eluted [^{99m}Tc]TcO₄⁻ from these high-current irradiations was assayed with a dose calibrator. The [^{99m}Tc]TcO₄⁻ was then evaluated for Al³⁺ concentration using the aurintricarboxylic acid spot test, pH using a colorimetric spot test, radionuclidic purity via γ-ray spectroscopy, and radiochemical purity via ITLC. A fraction of the collected [^{99m}Tc]TcO₄⁻ was also used to label MDP in which the stability was evaluated by ITLC.

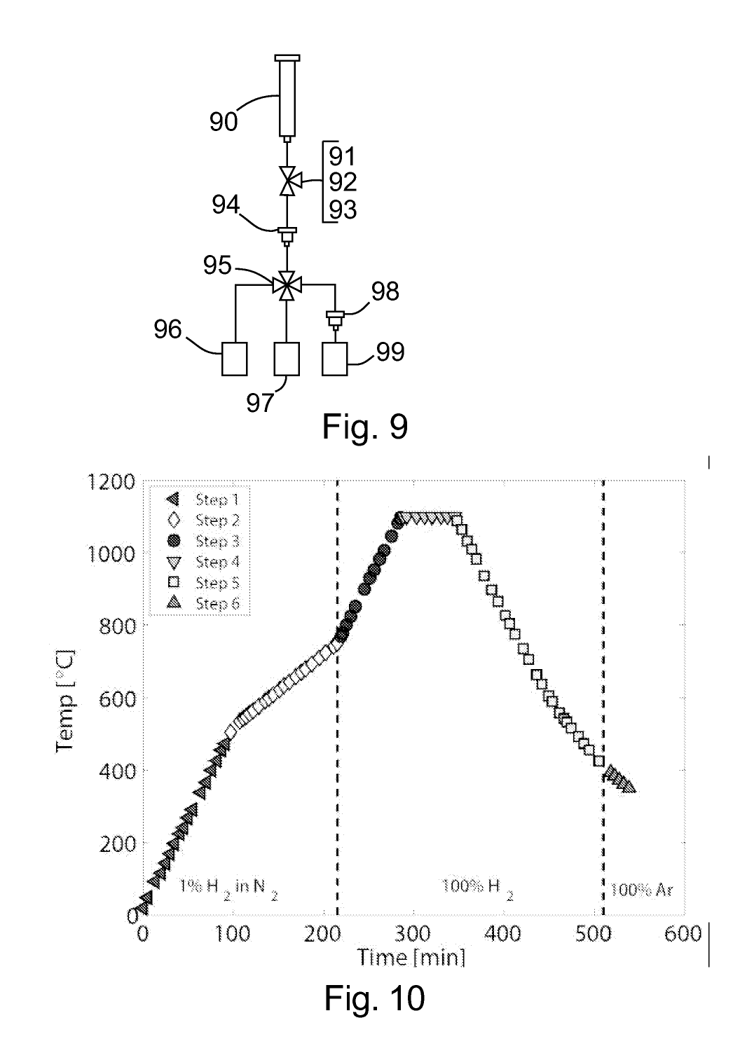

Example 2 of ^{99m}Tc separation from irradiated targets: This process was carried out on the samples indicated as “New” in Table 4. Following subsequent steps of molybdate isolation, reduction to molybdenum metal, and preparation of three additional targets with this recycled material, this technetium separation scheme was once again carried out on the samples indicated as “Recycled” in Table 4. Following peroxide dissolution and basification with (NH₄)₂CO₃ of the ¹⁰⁰Mo target irradiations outlined in Table 4, technetium was manually extracted by loading the dissolved oxidized target solution into an inverted 30 mL syringe 90 as noted in FIG. 9. The target solution was then directed through a 3-way valve (91-93) over a freshly prepared cartridge 94 of 484±13 mg (484±2 mg for the recycled ¹⁰⁰Mo) 100-200 mesh, ABEC-2000 resin (Eichrom) preconditioned with 20 mL of 3M (NH₄)₂CO₃. A new resin cartridge was prepared for each separation. The ABEC resin retains the [^{99m}Tc]pertechnetate while the enriched [¹⁰⁰Mo]molybdate is eluted 96 in the initial high ionic fraction. The line and resin were rinsed with 1 mL of 3M (NH₄)₂CO₃ to maximize ¹⁰⁰Mo recovery 96 and then cleared with 5 mL of air. The molybdate eluate was collected for future recycling. Next, residual ammonia on the resin was removed by eluting 95, 97 with 3 mL of 1M Na₂CO₃ (Aldrich, ACS Grade) followed by 5 mL of air into a waste vial. The high salt concentrations were necessary to prevent the pertechnetate from eluting. Finally, [^{99m}Tc]pertechnetate was eluted 95, 99 from the resin using 7-10 mL of 18 MΩ-cm H₂O (followed by 5 mL of air) and neutralized by passage through a Chromafix® PS-H strong cation exchange (SCX) cartridge 98 (preconditioned with 10 mL 18 MΩ-cm H₂O). Process times from start of dissolution to final isolated [^{99m}Tc]pertechnetate solution were less than 30 minutes.

For the target irradiations outlined in Table 4, and processed to extract ^{99m}Tc as outlined above, the dissolved molybdate solutions and recovered pertechnetate were further processed and evaluated as follows. An aliquot from the ¹⁰⁰Mo collection vial was removed for radionuclidic impurity analysis. To maximize the ¹⁰⁰Mo recovery, the initial target dissolution beaker was rinsed with 10 mL of 0.5 M (NH₄)₂CO₃. Both the primary ¹⁰⁰Mo collection vial and the vial with the additional 10 mL rinse of the dissolution beaker were set aside to decay.

An aliquot of the ^{99m}Tc was removed for QC evaluation. The activity of the eluted [^{99m}Tc]TcO₄⁻ was assayed (dose calibrator) and then evaluated for radiochemical purity, Al³⁺ concentration (aurintricarboxylic acid spot test) and pH. Colloidal technetium was evaluated using silica gel ITLC (in 0.9% saline), and free pertechnetate was evaluated using Whatman 31 ET chromatography paper (in acetone). A fraction of the collected [^{99m}Tc]TcO₄⁻ was also used to label MDP (stability evaluated via ITLC). The remaining ^{99m}Tc (approx. 1.5-2.5 GBq) was used for further radiopharmaceutical labelling studies. Following irradiation of new (N=4) ¹⁰⁰ Mo, the extracted [^{99m}Tc]TcO₄⁻ had a pH between 5.0 and 7.0, radiochemical purity of >99% TcO₄⁻ and an Al³⁺ concentration of <2.5 μg/mL. Following irradiation of recycled (N=3) ¹⁰⁰Mo, the extracted [^{99m}Tc]TcO₄⁻ had a pH between 6.0 and 6.5, radiochemical purity of >99% TcO₄⁻ and an Al³⁺ concentration of <2.5 μg/mL. The limits outlined by the United States Pharmacopeia (USP) pertechnetate monograph (2011) are a pH of between 4.5 and 7.5, radiochemical purity of >95% TcO₄⁻ and an Al³⁺ concentration of <10 μg/mL. All values are within the limits outlined by the United States Pharmacopeia (USP) pertechnetate monograph (2011).

The relative radionuclidic impurities in the ¹⁰⁰Mo and ^{99m}Tc aliquots (typically ˜1-20 μL) were determined via γ-ray spectrometry using an HPGe detector (Ortec model GEM35P4-S). The weighted average of the decay corrected EOB activities for three technetium impurities were evaluated (each impurity is individually reported as a percentage of the total ^{99m}Tc activity). Impurities of both new and recycled ¹⁰⁰Mo are in agreement within two standard deviations. The percent of ^{94g}Tc impurity activity to ^{99m}Tc activity at EOB was 0.019±0.002% for new ¹⁰⁰Mo (N=3 as sample 2-N of Table 4 was not evaluated due to an untimely power outage causing the sample to be assayed >24 hours post-EOB) and 0.023±0.002% for recycled ¹⁰⁰Mo (N=3). The percent of ^{95g}Tc impurity activity to ^{99m}Tc activity at EOB was 0.040±0.002% for new ¹⁰⁰Mo (N=4) and 0.043±0.002% for recycled ¹⁰⁰Mo (N=3). The percent of ^{96g}Tc impurity activity to ^{99m}Tc activity at EOB was 0.015±0.001% for new ¹⁰⁰Mo (N=4) and 0.016±0.001% for recycled ¹⁰⁰Mo (N=3).

Observations showed that the chemical niobium and molybdenum in this experiment are not retained by the ABEC resin. However, contaminant ¹⁸¹Re and ^{182m}Re (i.e. <0.05% and <0.5% of the ^{99m}Tc EOB activity, respectively) were observed in the recycled ¹⁰⁰Mo, but not the new ¹⁰⁰Mo. This source of Re is attributed to contamination (and subsequent activation) from the tungsten boats during the reduction process. No further non-technetium gamma emitting radionuclidic contaminants were identified in the ^{99m}Tc aliquots.

Comparison of in vivo uptake of MDP labelled with ^{99m}Tc from proton irradiation of recycled ¹⁰⁰Mo vs. generator produced ^{99m}Tc for rabbits showed no qualitative differences.

The conversion from molybdate→molybdenum metal is well known in the literature. The starting molybdate is usually in the form of either MoO₃, or ammonium molybdate (which can take one of several forms: including but not limited to (NH₄)₆Mo₂O₂₄, (NH₄)₆Mo₂O₂₄.4H₂O, (NH₄)₂Mo₂O₇, (NH₄)₂MoO₄). ¹⁰⁰Mo₃ is reduced back to ¹⁰⁰Mo by heating in the presence of hydrogen gas; however, in other applications the reduction of ammonium molybdate (AM) in this reduction process has been reported to provide Mo metal powder with better sintering properties when compared to reduced MoO₃. The isolation of ammonium molybdate can be achieved by the use of filtration or the evaporation of volatile salts for example. Since ammonium molybdate is reported to decompose to MoO₃ in hot water, it is for this reason that lyophilzation (rather than evaporation via heating of the dissolved molybdenum solution) was implemented in these studies. Heating of the solution to evaporate the salts and water might be a reasonable alternative if a lyophilisation system is not readily available.

Isolating ammonium molybdate (strategy #1: use of volatile salts): As an end product of the Tc/Mo separation, we have AM. There will also be other ions/salts present. If we choose wisely, we can use volatile salts so that these contaminants can simply be evaporated off. This is the case when peroxide is used for dissolution and ammonium carbonate for neutralization in concentrations ranging from 0.5M to 3M. Higher concentrations result in the large quantities of salt in the sample, which take extended periods of time to remove.

Isolating ammonium molybdate (strategy #2: use of filtration): If nitric acid is added, the resulting mixture contains AM, ammonium nitrate, and any other nitrate contaminants. AM is insoluble in ethanol or methanol, while many other nitrates are soluble (e.g. zinc nitrate, ammonium nitrate, copper nitrate, aluminum nitrate, ammonium nitrate, etc). This allows AM to be isolated from these impurities via filtration. While the use of volatile salts is preferred over the filtration strategy (since there is a greater potential for mass loss on the filter paper), the filtration strategy is a viable alternative if there was a potential for having other contaminants in the system (e.g. if a target support plate of copper was used: there could potentially be a copper nitrate contaminant present in the final AM product which could be removed via filtration). It should be noted that molybdenum solutions contaminated with additional cations (e.g. aluminum, copper, cobalt, etc.) may be purified prior to reduction through addition of nitric acid, and separated (e.g. filtration, centrifugation, etc.) based on the relative solubility of ammonium molybdate and contaminant nitrates in alcohol.

Isolating ammonium molybdate (evaporating the water [& salt]): be it the filtration method or the volatilization method, we must somehow remove the water from the system. AM is reported to decompose in hot water. To circumvent this problem lyophilization (i.e. freeze drying) was used to drive off the water and volatile salts. For the case of filtration, the dried mixture is then brought up in (e.g. methanol or ethanol), filtered, and the precipitate of AM is collected.

Example of molybdate isolation: Four sets of primary collection (and rinse) vials were pooled for molybdenum recycling (Table 4). The solution was passed through a 0.22 μm (Millex®-GP) filter. The water and volatile salts were removed by lyophilization of the ¹⁰⁰Mo ammonium molybdate solution (Labconco, 12 L, Model 77540). With the purified and dried AM, we are now ready to reduce the molybdate to molybdenum metal. The following conversion step is based on known techniques. Our experiments to date have been performed by placing the AM into a tungsten boat in a tube furnace. Tungsten isn't necessarily the only boat material which could be used. Also, while the tube furnace for our current experiments is static, a rotary tube furnace could also be used. The optimization of this procedure by changing the material of the boat, the rate of temperature change, H₂ concentration and flow rate may be determined by routine experimentation.

Molybdenum reduction example: The isolated ammonium molybdate powder was divided into three tungsten boats (25.4 mm W×58.8 mm L×2.4 mm deep, Ted Pella, Inc.), and placed into a tube furnace (74 mm I.D. Carbolite, TZF 16/610). The reduction of ammonium molybdate to molybdenum metal at elevated temperatures is a known three-step process which includes decomposition of ammonium molybdate to MoO₃, hydrogen reduction of MoO₃ to MoO₂, and finally hydrogen reduction of MoO₂ to Mo metal. The conversion of MoO₃ to MoO₂ is an exothermic process, and if excessive heat evolution occurs, the local temperature may result in volatilization of MoO₃. To avoid significant losses of the enriched target material, we limited the reaction rate for the MoO₃ to MoO₂ step by using low concentration H₂ gas (i.e. 1% H₂ in N₂, Praxair certified standard) and maintaining a decreased temperature ramp rate. Once beyond 750° C. (i.e. the temperature whereby the MoO₃ to MoO₂ reduction was considered to be completed), the flow rates were increased, and the atmosphere set to pure hydrogen (UHP 5.0). FIG. 10 shows measured temperature profiles and the actual programmed temperature steps were: In step 1 the temperature was increased from 25° C. to 500° C., with a programmed temperature rate of 5° C./min in an atmosphere of 1% H₂ in N₂ and a nominal flow rate of 500 sccm. In step 2 the temperature was increased from 500° C. to 750° C., with a programmed temperature rate of 2° C./min in an atmosphere of 1% H₂ in N₂ and a nominal flow rate of 500 sccm. In step 3 the temperature was increased from 750° C. to 1100° C., with a programmed temperature rate of 5° C./min in an atmosphere of 100% H₂ and a nominal flow rate of 1000 sccm. In step 4 the temperature was held at 1100° C. 1 hour in an atmosphere of 100% H₂ and a nominal flow rate of 1000 sccm. In step 5 the temperature was decreased from 1100° C. to 400° C., with a programmed temperature rate of −5° C./min in an atmosphere of 100% H₂ and a nominal flow rate of 1000 sccm. In step 6 the temperature was decreased from 400° C. to 25° C., with a programmed temperature rate of −5° C./min in an atmosphere of 100% Ar and a nominal flow rate of 1000 sccm.

Steps 1, 2, and 3, were designed to decompose the ammonium molybdate, and reduce both MoO₃, and MoO₂, respectively. Step 4 was in place to ensure complete reduction prior to cooling (i.e. Steps 5 and 6). Reduction of the ammonium molybdate to molybdenum metal was confirmed by x-ray diffraction (XRD) on samples of the isolated ¹⁰⁰Mo both pre/post reduction.

Based on the relative mass abundance of molybdenum in the various forms of ammonium molybdate, we conclude that the efficiency of the reduction step was greater than 95%. An overall metal to metal recovery of 87% was obtained for the recycling process after correcting for controlled sampling of the ¹⁰⁰Mo (i.e. 53.5 mg ammonium molybdate removed for powder XRD prior to reduction).

Evaluation of the molybdenum isotopic composition was considered important for two reasons. First, due to the wide array of nuclear reaction schemes which may give rise to molybdenum isotopes (either directly, e.g. ¹⁰⁰Mo(p,t)⁹⁸Mo [Q-value=−5.7 MeV], or indirectly, e.g. ¹⁰⁰Mo(p,α)⁹⁷Nb→⁹⁷Mo [Q-value=4.3 MeV]), a small possibility exists that the molybdenum composition may change by virtue of the irradiation itself. Second, we were concerned with the introduction of ^{nat}Mo impurities present in the solvents used for target dissolution and ^{99m}Tc extraction. The molybdenum isotopic composition was evaluated via ICP-MS. No changes in the molybdenum isotopic composition between new and recycled ¹⁰⁰Mo were observed (as shown Table 3). The reason for the discrepancies between our measured enrichment and the enrichment reported by the Isoflex certificate of analysis (COA) is unknown. The measured isotopic composition for new ¹⁰⁰Mo is 0.03% ⁹²Mo, 0.02% ⁹⁴Mo, 0.04% ⁹⁵Mo, 0.05% ⁹⁶Mo, 0.04% ⁹⁷Mo, 0.45% ⁹⁸Mo and 99.37% ¹⁰⁰Mo. The measured isotopic composition for recycled ¹⁰⁰Mo is 0.03% ⁹²Mo, 0.02% ⁹⁴Mo, 0.04% ⁹⁵Mo, 0.05% ⁹⁶Mo, 0.04% ⁹⁷Mo, 0.45% ⁹⁸Mo and 99.37%¹⁰⁰Mo. The nominal (Isoflex COA) isotopic composition for new ¹⁰⁰Mo is 0.06% ⁹²Mo, 0.03% ⁹⁴Mo, 0.04% ⁹⁵Mo, 0.05% ⁹⁶Mo, 0.08% ⁹⁷Mo, 0.47% ⁹⁸Mo and 99.27% ¹⁰⁰Mo.

The efficient recycling of enriched metallic ¹⁰⁰Mo targets has been demonstrated. The process recycles enriched ¹⁰⁰Mo metal targets using ammonium molybdate purification by ^{99m}Tc extraction from a dissolved ¹⁰⁰Mo metal target, purification of the resulting ammonium molybdate, and hydrogen reduction back to the metallic molybdenum with a metal to metal recovery yield of 87%. Careful selection of the ions introduced during target dissolution and basification was made to allow for the isolation of ammonium molybdate by lyophilization in such form that additional purification was not required before reduction of the molybdate back to molybdenum. It is expected that this will be improved by working with larger quantities of material (e.g. greater than a few grams). It is compatible with the production of large quantities of ^{99m}Tc on a routine basis. The recycled ¹⁰⁰Mo has been fabricated into a new target and used to produce [^{99m}Ta]TcO₄ that is comparable to generator derived ^{99m}Tc.

The ¹⁰⁰Mo prepared in this study has been evaluated by ICP-MS, and no difference in the measured isotopic composition of new vs. recycled ¹⁰⁰Mo are reported. The [^{99m}Tc]pertechnetate obtained following irradiation of new or recycled ¹⁰⁰Mo had values for the pH, radiochemical purity, and Al³⁺ concentration that were in accord with USP recommendations. While radionuclidic purity evaluation revealed no differences in the ^{94g}Tc, ^{95g}Tc, and ^{96g}Tc impurities following irradiation of new or recycled ¹⁰⁰Mo, radionuclidic contaminants of ¹⁸¹Re and ^{182m}Re were noted following irradiation of recycled ¹⁰⁰Mo. As these contaminants may yield increased dose and degrade image quality (i.e. due to the high energy γ-rays of ^{182m}Re), these contaminants can be mitigated by using tantalum or quartz boats as opposed to tungsten. For the purpose of reducing larger quantities of ammonium molybdate, the use of a quartz rotary reactor tube furnace (e.g. Carbolite HTR) is another option.

While the focus of these descriptions is on the cyclotron production of ^{99m}Tc, the methodology can be applied to the cyclotron production of other medically relevant technetium isotopes (e.g. ^{94m}Tc). Furthermore, although we have implemented the ABEC separation scheme in these experiments, it should be possible to extend the proposed recycling methodology to other existing ^{99m}Tc extraction schemes.

Preliminary biodistribution data indicate no significant difference in the biological handling of MDP when labelled by ^{99m}Tc produced by the cyclotron irradiation and isotope separation process described herein or ^{99m}Tc generated using the nuclear generator derived material. Whilst quantitative analysis has not been performed, the equivalence of imaging parameters, counts and biodistribution suggest that MDP labelled with cyclotron production of ^{99m}Tc using recycling of enriched ¹⁰⁰Mo metal targets will offer a new route to the routine production of clinical radiopharmaceuticals in clinical nuclear medicine practice. Cyclotron and generator-based ^{99m}Tc-labeled disofenin as well as pertechnetate had similar QA/QC data, in vivo uptake images, and bio-distribution data.

1. A method of the preparation of a technetium isotope, comprising:
irradiating a molybdenum metal target with charged particles to produce a technetium isotope;
separating the technetium isotope following irradiation of the molybdenum metal;
re-claiming the molybdenum metal; and
reforming the molybdenum metal into a further molybdenum target for a further irradiation step by bonding the molybdenum metal to a target support.

2. The method of claim 1 in which bonding the molybdenum metal to the target support comprises applying heat and pressure to a pellet of the molybdenum metal.

3. The method of claim 2 in which the pressure is applied under vacuum.

4. The method of claim 1 in which reforming the molybdenum metal comprises pressing molybdenum metal powder and sintering the resulting pressed molybdenum metal powder to produce a pellet of the molybdenum metal before bonding the molybdenum metal pellet to a support.

5. The method of claim 4 in which the sintering is carried out under a reducing atmosphere.

6. The method of claim 4 in which the pressed molybdenum metal is supported during sintering by a sintering support plate that is removed after sintering.

7. The method of claim 5 in which the support is formed from a first material and the molybdenum metal is supported during sintering by a second material and the second material has a higher melting point than the first material.

8. The method of claim 5 in which the pressed molybdenum metal is supported by an additional mass during sintering that is separated from the molybdenum metal pellet after sintering.

9. The method of claim 8 in which the sintering support plate is made of any one or more of Ta, Ti, Pt, Zr, Cr, V, Rh, Hf, Ru, Ir, Nb, Os, alumina, zirconia and graphite.

10. The method of claim 8 in which the additional mass comprises a cap.

11. The method of claim 10 in which the cap is made of any one or more of Ta, Ti, Pt, Zr, Cr, V, Rh, Hf, Ru, Ir, Nb, Os, alumina, zirconia and graphite.

12. The method of claim 1 in which the target support comprises one or more of Al, Ag, Pt, Au, Ta, Ti, V, Ni, Zn, Zr, Nb, Ru, Rh, Pd and Ir.

13. The method of claim 1 in which separating the technetium isotope comprises dissolving the molybdenum metal target to remove the molybdenum from the target support, and isolating the technetium isotope.

14. The method of claim 13 in which separating the technetium isotope comprises oxidizing the molybdenum metal target to soluble molybdate using hydrogen peroxide to form a solution, and the technetium isotope is isolated as pertechnate.

15. The method of claim 14 further comprising isolating the molybdate by lyophilization and reducing the isolated molybdate to molybdenum metal.

16. The method of claim 14 in which separating the technetium isotope comprises neutralizing the solution.

17. The method of claim 13 in which dissolving takes place under dissolution conditions and the target support is impervious to the dissolution conditions.

18. The method of claim 13 in which isolating the technetium isotope comprises using aqueous biphasic extraction chromatography.

19. The method of claim 1 in which the technetium isotope is ^{99m}Tc or ^{94m}Tc.

20. A method for the preparation of a molybdenum metal target for irradiating with charged particles to produce a technetium isotope comprising bonding molybdenum metal to a target support.

21. The method of claim 20 in which bonding the molybdenum metal to the target support comprises applying heat and pressure to a pellet of molybdenum metal under vacuum.

22. The method of claim 20 further comprising pressing molybdenum metal powder and sintering the pressed molybdenum metal powder to produce a pellet of molybdenum metal before bonding the molybdenum metal to the support.

23. The method of claim 22 in which sintering is carried out under a reducing atmosphere.

24. The method of claim 22 in which the pressed molybdenum metal is supported during sintering by a sintering support plate that is removed after sintering.

25. The method of claim 22 in which the pressed molybdenum metal is supported by an additional mass during sintering that is separated from the molybdenum metal pellet after sintering.

26. The method of claim 24 in which the sintering support plate is made of any one or more of Ta, Ti, Pt, Zr, Cr, V, Rh, Hf, Ru, Ir, Nb, Os, alumina, zirconia and graphite.

27. The method of claim 25 in which the additional mass comprises a cap.

28. The method of claim 27 in which the cap made of any one or more of Ta, Ti, Pt, Zr, Cr, V, Rh, Hf, Ru, Ir, Nb, Os, alumina, zirconia and graphite

29. The method of claim 20 in which the target support comprises one or more of Al, Ag, Pt, Au, Ta, Ti, V, Ni, Zn, Zr, Nb, Ru, Rh, Pd and Ir.

30. A method of the preparation of a technetium isotope, comprising:
irradiating a molybdenum metal target with charged particles to produce a technetium isotope;
separating the technetium isotope following irradiation of the molybdenum metal by dissolving the molybdenum metal target to remove the molybdenum from the target support and isolating the technetium isotope;
re-claiming the molybdenum metal; and
reforming the molybdenum metal into a further molybdenum target for a further irradiation step.

31. The method of claim 30 in which separating the technetium isotope comprises oxidizing the molybdenum metal target to soluble molybdate using hydrogen peroxide to form a solution, and the technetium isotope is isolated as pertechnate.

32. The method of claim 31 further comprising isolating the molybdate by lyophilization and reducing the isolated molybdate to molybdenum metal.

33. The method of claim 32 further comprising neutralizing the solution and isolating the technetium isotope as pertechnate.

34. The method of claim 33 in which neutralization is carried out with ammonium carbonate.

35. The method of claim 30 in which dissolving takes place under dissolution conditions and the target support is impervious to the dissolution conditions.

36. The method of claim 30 in which isolating the technetium isotope comprises using aqueous biphasic extraction chromatography.

37. The method of claim 29 in which the technetium isotope is 99 mTc or 94 mTc.

38. A method of the preparation of a technetium isotope, comprising:
irradiating a molybdenum metal target with charged particles to produce a technetium isotope;
separating the technetium isotope following irradiation of the molybdenum metal;
re-claiming the molybdenum metal; and
reforming the molybdenum metal into a further molybdenum target for a further irradiation step.
